(19) United States
(12) Patent Application Publication
(10) Pub. No.: US 2006/0163303 A1
(43) Pub. Date: Jul. 27, 2006

(54) Method and apparatus for advertising using portable flat screen video equipped backpacks

(76) Inventor: Anthony Trutanich, Los Angeles, CA (US)

Correspondence Address: ZUBER & TAILLIEU, 9TH FLOOR, 9595 WILSHIRE BLVD., BEVERLY HILLS, CA, 90212, US

(21) Appl. No.: 11/044,403

(22) Filed: Jan. 27, 2005

(51) Int. Cl. A45C 15/00; G09G 5/00; G06F 1/16

(52) U.S. Cl. 224/576; 224/627; 224/645; 224/930; 345/8; 361/681

(57) ABSTRACT

A video equipped backpack comprising a rectangular shaped opening formed within a back panel of the backpack, a flat panel display coupled to the backpack such that a display area of said flat panel display is visible through the rectangular shaped opening, and an image source housed within said backpack and coupled to the flat panel display which transmits video signals to the display for viewing. The image source may be comprised of a portable DVD player or mini-computer with video processing unit such that the entire unit is self contained. Alternatively, the image source may include a broadcast video signal receiving unit for receiving broadcast video signals from a centrally located video signal transmission unit. Ideally, the backpack will be used in concert with other identical backpack systems in order to convey video information to large groups of people all present at an enclosed function, such as a party or sporting event.

### FIELD OF THE INVENTION

The present invention relates to an improved method and apparatus for communicating information to groups of people at the same time, and more particularly to a portable flat screen video pack which can be used for providing video information and advertising to large groups of individuals.

### PRIOR ART

Prior art video communication systems for providing video information and advertising may be accomplished through any one of several known means. For example, television networks can send video images, including commercial advertising, to viewers on a large scale through the use of a complex network of television cabling systems and television screens. Similarly, computer communication can send video images, including commercial advertising, to viewers on a large scale through the use of the internet or a local intranet and display terminals.

One feature common to all of these known video communications systems is that in order for the user to view the video information provided, he or she must be located nearby the video display in order to view the images provided. While this is an effective means of communicating information to a sedentary viewer, it is ineffective for communication of video-information to a potential viewer who may be moving about a large space. For example, if there are one hundred potential viewers moving about a two thousand (2000) square foot space, multiple video displays must be positioned about the entire space in order to ensure that every user has access and ability to view the video information which may be provided. Alternatively, the number of displays may be reduced if the size of each display is increased, thereby increasing the range of useful viewing from which an individual may view such a display. The cost of such a video system can increase dramatically as the number and/or size of video displays utilized in such an environment increases.

It would therefore be advantageous to have at least one portable video system which could be mobilized and worn by an individual who could then move about the 2000 sq. fit space in order to convey specific video information and advertising to large groups of individuals at the same time. Having such a mobile video system would ensure that the video information may be viewed by even those individuals who may not be within proximity of a stationary display. This would reduce the number of display units needed and, therefore, reduce the costs of developing and providing such a large scale video system.

### OBJECT OF THE INVENTION

It is an object of the invention to provide a video communications system which may be used to provide video information, including commercial and advertising information, to viewers within a large space, via at least one mobile display. It is a further object of the invention to provide a portable video system which can be mobilized and worn by an individual in order to convey specific video information and advertising to large groups of individuals without requiring each individual to be within proximity of a stationary display.

It would be advantageous if the video system included a flat panel display integral to a backpack which could be worn by an individual. It would be further advantageous if the backpack included a receiver for receiving a broadcast image from a remote image source, which would then be displayed on said flat panel display. Alternatively, the backpack may include a local image source, disposed within the backpack and coupled to the display. The backpack would also preferably include a small portable power supply which would be coupled to both the receiver/image source and the display. It would be further advantageous to have an entire system comprised of multiple video equipped or video capable backpacks which can each communicate with a central processor and transmission unit in order to receive and broadcast video information and advertising to large groups of individuals. Further objects and advantages of the invention will become apparent from a consideration of the drawings and ensuing description.

### SUMMARY OF THE INVENTION

The invention includes a video communications system which may be used to provide video information, including commercial and advertising information, to viewers within a large space, via at least one mobile video display. The video communications systems preferably includes a video equipped backpack having a flat panel video display which is preferably implemented within a backpack design. Having the display implemented within a backpack design allows the backpack to be worn by an individual and the flat panel video display to be moved about with the wearer, in order to convey specific video information and advertising to large groups of individuals without requiring each such individual to be within immediate proximity of a stationary display. Instead, the individual wearing the backpack designed with a built in flat panel video display will circulate about the viewers within a large space, thereby providing ability and opportunity for each viewer to view the display.

In a preferred embodiment, the video system includes a flat panel display integral to a backpack which can be worn by an individual. The flat panel video display is preferably of a thin, light weight design and comprised of a liquid crystal display (LCD), plasma display or similar technology. The display is integral to a backpack such that the outer, visible surface of the display is nearly flush with the surface of the backpack. The backpack also houses an image source coupled to the flat panel display for providing video images signals to the display and a small power supply coupled to both the flat panel display and the image source for driving the unit.

In a preferred embodiment, several video capable backpacks are utilized within a single video communications system, with each individual video capable backpack having the ability to communicate with a central processor and central transmission unit in order to receive broadcast video information, such as video advertisements, and display such information on each individual video display, thereby providing video information and advertising to large groups of individuals. Further objects and advantages of the invention will become apparent from a consideration of the drawings and ensuing description.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 illustrates a perspective view of a video communications system in accordance with a preferred embodiment of the present invention;

FIG. 2 illustrates a side view of a video communications system in accordance with a preferred embodiment of the present invention;

FIG. 3 illustrates a rear view of a video communications system in accordance with a preferred embodiment of the present invention;

FIG. 4 illustrates a break-out perspective view of both the backpack and the flat panel video display removed from the backpack;

FIG. 5 shows a close-up of the rectangular shaped opening formed within the back panel of the backpack and further illustrates one mechanism for coupling a flat panel display to the backpack such that the display is visible through the rectangular shaped opening;

FIG. 6 illustrates a front view of a preferred embodiment of a flat panel display having locking bars positioned along the side of the display such that the display may be coupled to and utilized in the backpack shown in FIG. 4;

FIG. 7 illustrates a side view of a preferred embodiment of a flat panel display having locking bars positioned along the side of the display such that the display may be coupled to and utilized in the backpack shown in FIG. 4;

FIG. 8 illustrates another preferred embodiment of the rectangular shaped opening formed within the back panel of the backpack and surrounded by velcro strips positioned on the inside surface of the backpack;

FIGS. 9a and 9b illustrate front and side views, respectively, of a preferred embodiment of a flat panel display having velcro strips positioned around the display such that the display may be coupled to and utilized in the backpack shown in FIG. 6; and

FIG. 10 illustrates one possible environmental configuration in which the communications system of the present invention might be used and shows several video equipped backpacks dispersed throughout a large, enclosed space and a central video transmission station which broadcasts video images to each of the video equipped backpacks.

### DETAILED DESCRIPTION OF PREFERRED EMBODIMENTS

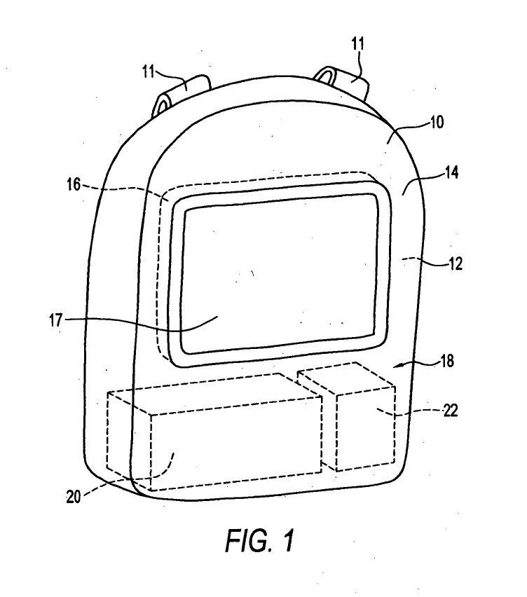

FIG. 1 illustrates a video communications system in accordance with a preferred embodiment of the present invention. As shown in FIG. 1, the system includes a rugged, lightweight internal framed backpack 10 having an internal, lightweight frame (not shown) made of plastic or other similar material and an outer shell/covering/casing made of vinyl, polyester, acrylic, or other similar material. Alternatively, the backpack 10 may be of a frameless design with the outer shell/covering/casing of the backpack made from vinyl, polyester, acrylic, suede, leather, or other similar material. Additionally, the shell/covering/casing comprising the backpack 10 may be formed of a more sturdy material such as plastic or lightweight graphite.

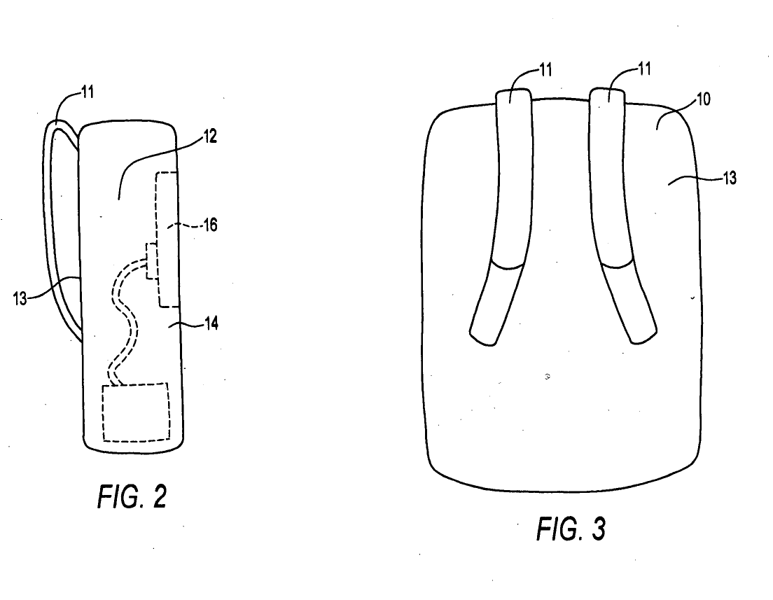

FIG. 2 illustrates a side view of the video communications backpack system in accordance with a preferred embodiment of the present invention. As shown, the backpack is preferably configured to extend to an overall width of approximately 6 to 9 inches and may have a height of approximately 12 to 18 inches. FIG. 3 illustrates a rear view of the video communications backpack system in accordance with a preferred embodiment of the present invention.

Referring to FIGS. 1-3, the backpack preferably includes anatomically curved shoulder straps 11 which fit over a user's shoulder when the backpack 10 is worn. The backpack 10 may also include an adjustable hipbelt (not shown), which secures about the waist of the user when the backpack is worn. Preferably, both the shoulder straps 11 and the hipbelt (if included) are sculpted to comfortably fit around a human body while evenly and efficiently distributing weight for true load-carrying ease. The shoulder straps 11 may be padded for additional comfort and the hipbelt may also be padded. If the backpack 10 is configured with a hipbelt then, preferably, the hip belt includes a self-equalizing hip cinch for adjusting the hipbelt around the waist when the backpack is worn.

The shell/covering/casing of the backpack further includes an inner pouch or cavity 12 for storage, as described further hereinafter. The shell/covering/casing of the backpack 10 also has a front side or panel 13, which will rest against the wearer's backside when the backpack 10 is worn, and a back side or panel 14 which faces outward, away from the wearer.

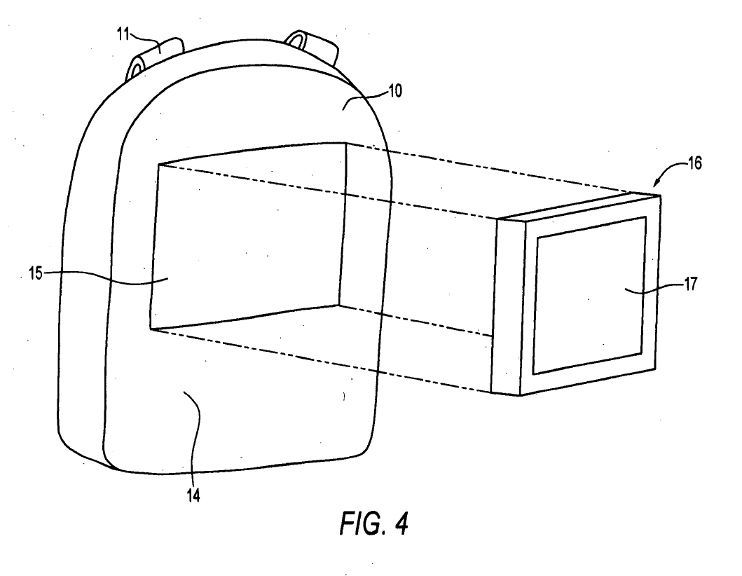

FIG. 4 illustrates a break-out perspective view of both the backpack 10 and a flat panel video display 16 which can be coupled to and/or removed from the backpack. Referring to FIG. 4, the back side or panel 14 of the backpack is configured with a rectangular shaped opening 15 formed therein. The rectangular shaped opening 15 is configured to allow a flat panel display 16 to be coupled to and integrated with the backpack 10 such that a display area 17 of the flat panel display 16 is visible through the rectangular opening 15 in the back side or panel 14 of the backpack 10. In a preferred embodiment, the flat panel display 16 is preferably positioned within the rectangular shaped opening 15 and coupled to the backpack 10 such that the visible surface of the display area 17 of the flat panel display 16 faces outward and is nearly flush with the back side or panel 14 of the backpack 10.

As described earlier with reference to FIGS. 1-3, the backpack further includes an inner pouch or cavity 12. The inner pouch or cavity is preferably large enough to accommodate an image source 20 from which information about the image to be displayed on the flat panel display 16 is received. The image source 20 is preferably coupled to the flat panel display 16 and transmits video signals to the display for viewing. The inner pouch or cavity 12 of the backpack 10 is also preferably large enough to house a small power supply 22, such as a portable rechargeable lithium battery.

In a preferred embodiment, the image source may be comprised of a broadcast video signal receiving unit. In this embodiment, a separate transmission unit will be positioned within proximity of the backpack 10 and will transmit a video signal to the backpack 10. The broadcast video receiving unit 20 within the backpack 10 will receive the transmitted signal and convert the signal into an appropriate digital format for viewing on the flat panel display screen 16. In this embodiment, the backpack 10 will also house a power supply 22, such as a portable rechargeable lithium battery, sufficient to provide necessary power to both the broadcast video signal receiving unit 20 and the drivers of the flat panel display 16.

Alternatively, the image source 20 may include a small miniature optical disc player, a portable DVD player, or a mini-computer with video processing unit. Miniature optical disc players, portable DVD players, and mini-computers equipped with video processing units are all well known in the art and the invention is intended to include all such known compact and portable methods of providing video signals to the flat panel display. The miniature optical disc player, portable DVD player, or mini-computer with video processing unit will provide RGB and/or digital video data signals to the flat panel display 16 for viewing on the visible display area 17 of the flat panel display 16. Preferably, the flat panel display 16 is configured to except NTSC and PAL standard video signals, as well as separate H & V synchronization signals.

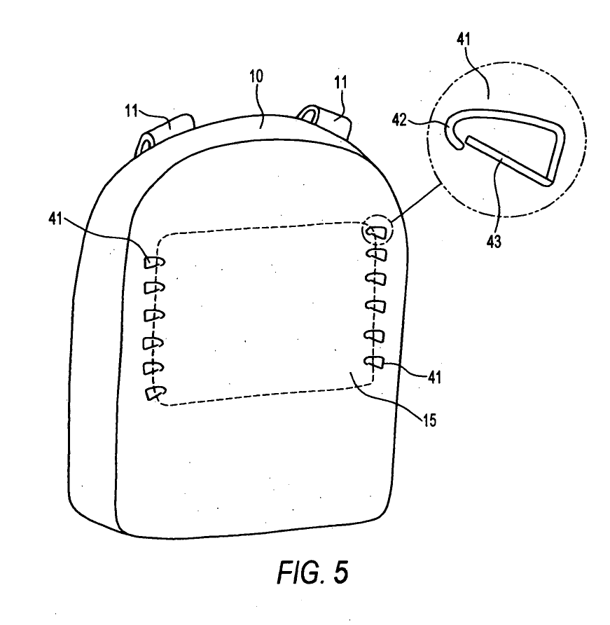

FIG. 5 illustrates a first preferred embodiment for coupling the flat panel display 16 to the backpack 10. More specificially, FIG. 5 illustrates the rectangular shaped opening 15 formed within the back side or panel 14 of the backpack 10 with the flat panel display removed. As shown in the embodiment illustrated in FIG. 5, the rectangular shaped opening 15 is surrounded on opposing sides by a plurality of miniature hook locking mechanisms 41 positioned about the opening 15 and coupled to the backpack 10. It is understood that the hook locking mechanisms 41 may be positioned on either two opposing sides of the rectangular opening 15 or may be positioned on all four sides of the rectangular shaped opening 15 for further stability and security.

FIG. 5 further includes a blow-up of a single hook locking mechanism 41. As shown, each hook locking mechanism 41 includes a small miniature clasp having a hook 42 and a locking hinge or flap 43. When pressure is applied to the locking hinge or flap 43 it opens inward, away from the hook 42, exposing the hook and allowing it to be hooked around or through a locking bar or ring (not shown). When pressure is removed, the locking hinge or flap 43 closes outward, engaging with the hook 42 and forming a closed loop about the locking bar or ring (not shown). In a preferred embodiment, the plurality of miniature hook locking mechanisms 42 will be used to couple a flat panel display 16 to the backpack 10, thereby forming one integral backpack having a flat panel display included therewith and coupled thereto.

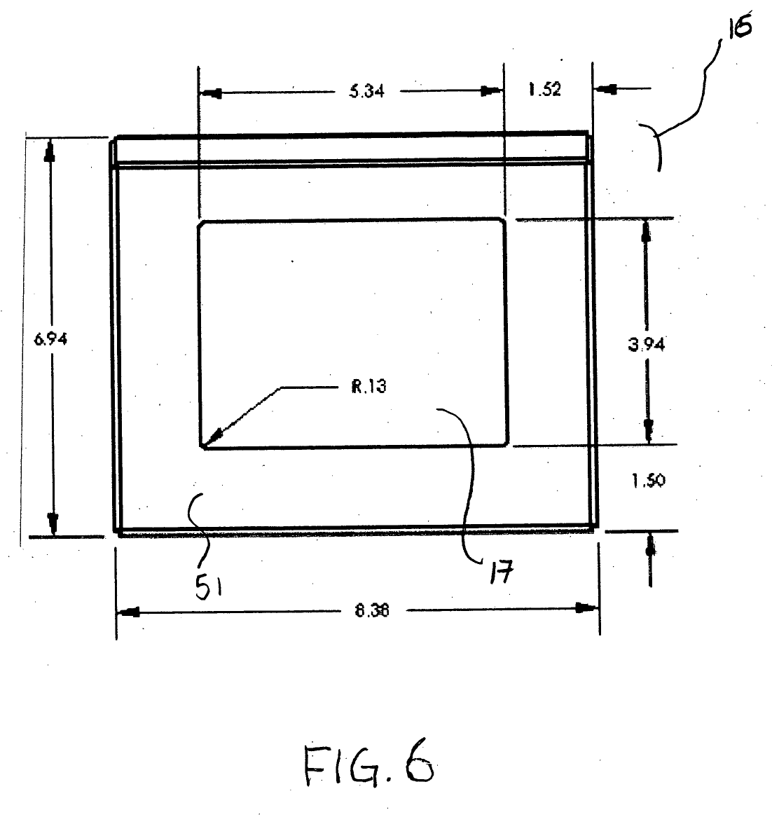

FIG. 6 illustrates a preferred embodiment of a flat panel display 15 which may be utilized within the backpack shown in FIG. 5. As shown, the flat panel display is preferably under fifteen (15) pounds and has at least a 5″ diagonal display area 17, similar to the type of displays used in lightweight portable DVD players (the display shown has a diagonal of 6.4″). In a preferred embodiment, the flat panel display will include at least a 5″ display area and will be comprised of an LCD, plasma, or other similar display. Additionally, the flat panel display 16 is preferably capable of providing images at a color resolution of at least 256 colors and is also capable of operating at ambient temperatures between 0 degrees Celsius and 50 degrees Celsius.

As further shown in FIG. 6, the flat panel display 16 preferably includes a display area 17 which is encased within and surrounded by an encasement 51 formed of a lightweight plastic or graphite material. The encasement 51 houses the electronics needed to convert incoming video signals and allow them to be displayed within the display area 17 of the flat panel display 16. The particular electronics used to receive and convert the incoming signals are well known in the art and it is intended that the invention include any and all such known methods for doing so, along with any obvious variations or extensions/modifications thereof.

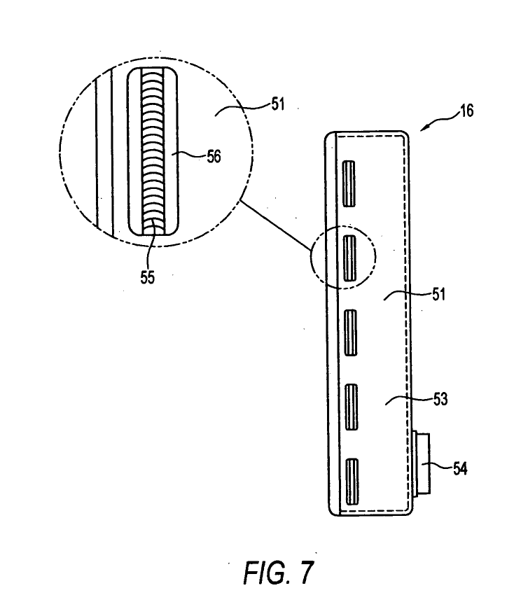

FIG. 7 illustrates a side view of a preferred embodiment of a flat panel display 16 having locking bars 55 positioned along the side of the display such that the display 16 may be coupled to and utilized in the backpack 10 shown in FIG. 5. As shown in FIG. 7, in a preferred embodiment, the flat panel display 16 preferably has a depth or thickness of approximately two inches or less. It also includes a signal receiving port 54 for coupling an image source 20, such as a broadcast video signal receiving unit, a miniature optical disc player, a portable DVD player, and/or a mini-computer equipped with a video processing unit, to the display 16. The signal receiving port 54 preferably receives RGB video signals along with separate H and V synchronization signals from the image source 20. Additionally, formed along the outer side edges 53 of the lightweight encasement 51 are a plurality of miniature locking bars or rings 55 which are positioned at select intervals along both sides of the flat panel display 16. Alternatively, miniature locking bars or rings 55 may be positioned on all sides of the flat panel display 16, thereby encircling the entire outer edge of the display at fairly even intervals.

FIG. 7 includes a blow-up of the miniature locking bars 55 formed along the sides of the flat panel display 16. As shown, a recess 56 is preferably formed within the encasement 51 and a miniature locking bar 55 is positioned to extend across the length of the recess thereby exposing the bar 55 on all sides such that it may be fully surrounded and gripped by one of the miniature hook locking mechanisms 41 (FIG. 5). The miniature locking bar or rings 55 are preferably formed of steel or metal, in order to provide durability and security. In a preferred embodiment, the plurality of miniature hook locking mechanisms 41 positioned about the rectangular shaped opening 15 in the backpack 10 will engage with each of the plurality of miniature locking bars or rings 55 of the flat panel display 16, in order to couple the flat panel display 16 to the backpack 10, thereby forming one integral backpack having a flat panel display included therewith and coupled thereto.

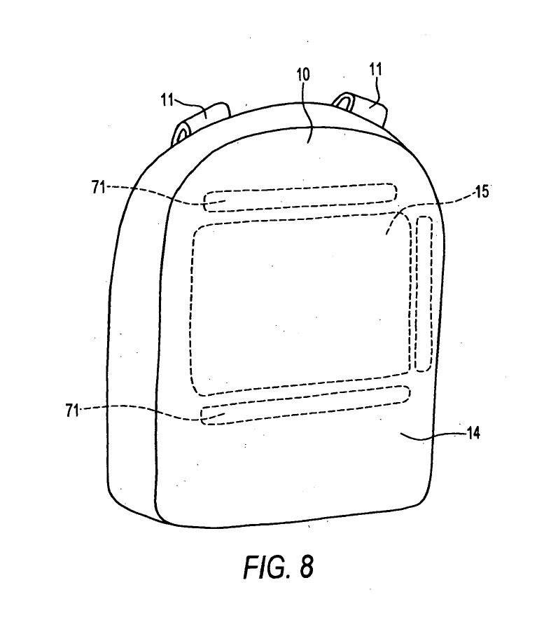

FIG. 8 illustrates another preferred embodiment of backpack 10 with the rectangular shaped opening 15 formed within the back panel 14 of the backpack 10. As shown, the backpack of FIG. 6 is identical to that shown in FIG. 1 through 5, except that the backpack of FIG. 8 does not include miniature hook locking mechanisms 41 positioned about the rectangular shaped opening 15 in the backpack 10. Instead, the rectangular shaped opening 15 is flanked by velcro strips 71. Preferably, the velcro strips 71 are positioned about all four sides of the rectangular shaped opening 15, on the inside surface of the backpack (as indicated by the dashed lines), thereby surrounding the rectangular shaped opening 15 on all four sides on the inside of the backpack. Alternatively, the velcro strips may be positioned on only two opposing sides of the rectangular shaped opening 15 on the inside of the backpack 10. Each velcro strip 71 is preferably at least one-half to one full inch in width. These velcro strips 71 will preferably engage opposing velcro strips positioned on and coupled to a flat panel display 16 such that the strips will be used to couple the flat panel display 16 to the backpack 10, thereby forming one integral backpack having a flat panel display included therewith and coupled thereto.

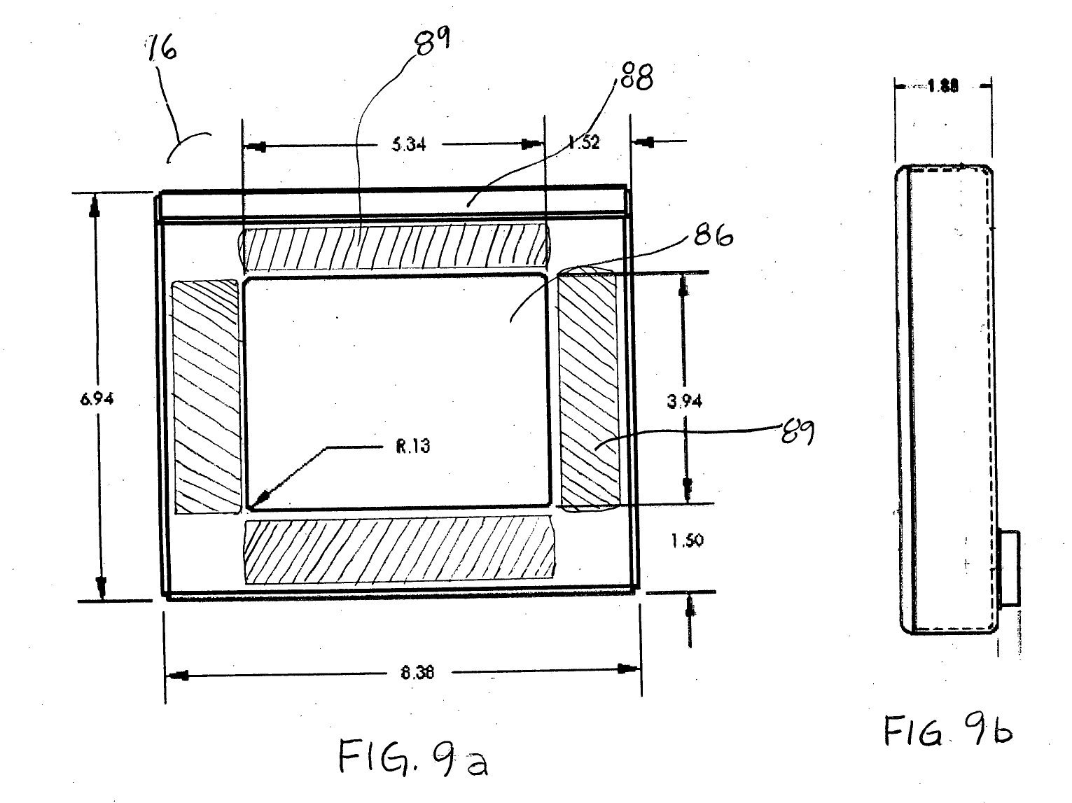

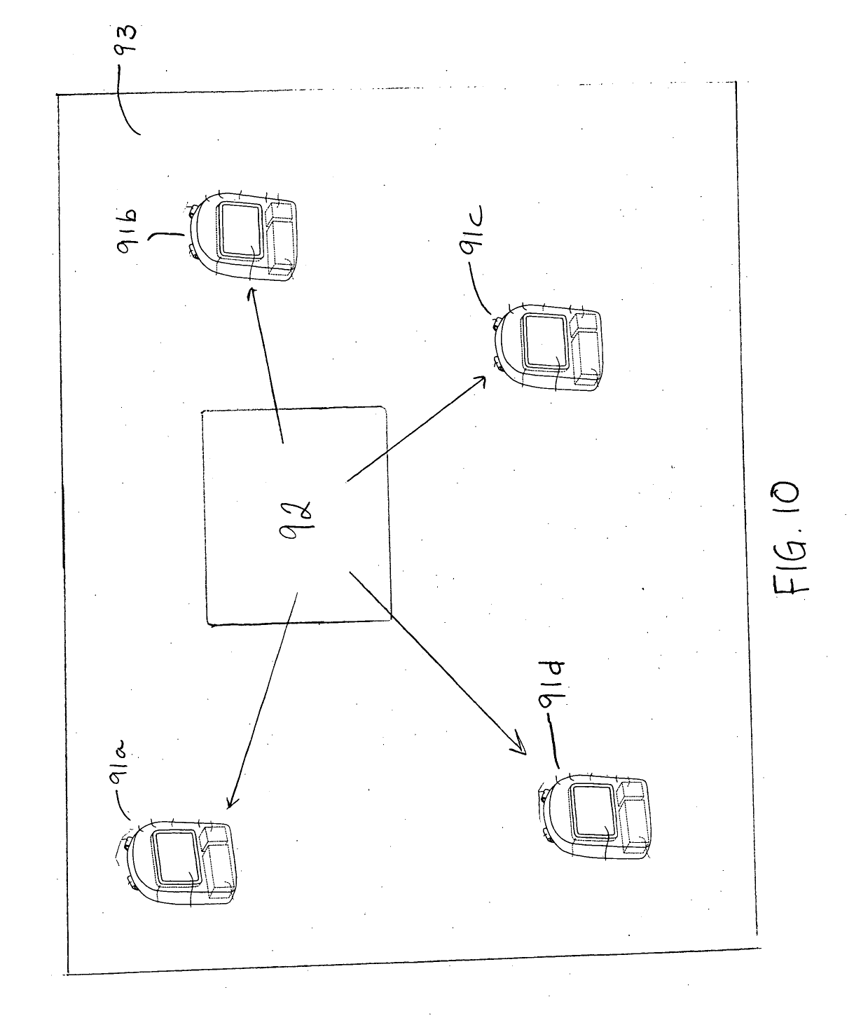

FIGS. 9a and 9b illustrate a preferred embodiment of a flat panel display 16 which may be utilized in the backpack shown in FIG. 8. As shown, the flat panel display 16 is nearly identical to that shown in FIGS. 6 and 7, with a few minor modifications. Once again, the flat panel display 16 is preferably under fifteen (15) pounds and has at least a 5″ diagonal display area 86, similar to the type of displays used in lightweight portable DVD players (the display shown has a diagonal of 6.4″). In a preferred embodiment, the flat panel display may be comprised of an LCD, plasma, or other similar display and is preferably capable of providing images at a color resolution of at least 256 colors. Preferably, the display is also capable of operating at ambient temperatures between 0 degrees Celsius and 50 degrees Celsius. Finally, referring to FIG. 9b, the flat panel display 16 preferably has a depth or thickness of approximately 2″ (two inches) or less.

As with the display shown in FIGS. 6 and 7, the flat panel display of FIGS. 9a and 9b is also encased within an encasement 88 which may be formed of a lightweight plastic or graphite material. The encasement houses the electronics needed to convert incoming video signals and allow them to be displayed within the display area 86 of the flat panel display. The particular electronics used to receive and convert the incoming signals are well known in the art and it is intended that the invention include any and all such known methods for doing so, along with any obvious variations or extensions/modifications thereof.

However, unlike the flat panel display shown in FIGS. 6 and 7, the encasement 88 of the display 16 shown in FIG. 9a does not include a plurality of miniature locking bars or rings 55 positioned along the sides of the encasement/display. Instead, in the preferred embodiment illustrated in FIGS. 9a and 9b, velcro strips 89 are coupled or glued to the front side of the encasement 88 along the edges of the lightweight plastic or graphite material, such that the velcro strips 89 flank the display area 86 on all four sides, thereby encircling the entire outer edge of the display area 86. Alternatively, the velcro strips 89 may be positioned on only two opposing sides of the display area of the flat panel display.

Each velcro strip is preferably at least one-half to one full inch in width and the velcro strips 89 of the encasement are used to couple with the velcro strips 71 positioned about the rectangular shaped opening 15 on the inside surface of the backpack 10, such that the velcro strips 89 coupled to or glued about the encasement of the flat panel display 81 will engaged with the velcro strips 71 of the backpack 10 in order to couple the flat panel display 81 to the backpack 10 while allowing the visible surface of the actual display area 86 to be viewed through the rectangular shaped opening 15 in the back panel of the backpack 10 and thereby forming one integral backpack having a flat panel display included therewith and coupled thereto.

Ideally, the backpack 10 will be used in concert with other identical backpack systems in order to convey video information to large groups of people all present at an enclosed function, such as a party or sporting event. Such a system would allow for target advertising to reach groups of people with the same or similar interests. FIG. 10 illustrates one possible environmental configuration in which the communications system of the present invention might be used.

As shown in FIG. 10, several video equipped backpack systems 91a-d are positioned and dispersed throughout a large, enclosed space 93. The backpack systems 91a-d are preferably worn by individuals who will each, in turn, move about the large, enclosed space 93, thereby allowing the video equipped backpack systems to be viewed by everyone within the large, enclosed space. In this embodiment, the video equipped backpack systems 91a-d each contain a video source 20 comprised of a broadcast video signal receiving unit. The broadcast video signal receiving unit is coupled to the flat panel display of the backpack for displaying received images. In this embodiment, a single video signal transmission unit 92 is located centrally within the large, enclosed space 93. This centrally located transmission unit 92 will preferably broadcast a video transmission signal over a wireless intranetwork set up within the large, enclosed space. Methods and apparatus for broadcasting video image signals over a wireless network are well known in the art and it is intended that the invention include any and all such known methods for doing so, along with any obvious variations or extensions/modifications thereof.

In a first preferred embodiment, the video signal transmitted by the centrally located transmission unit 92 may have any type of desired content including music videos, short films, news reports, sports highlights and scores, weather reports, or commercial advertisements. In this preferred embodiment, the same signal is transmitted out to each broadcast video signal receiving unit within each video system equipped backpack such that each backpack will receive and display the same video information on its respective flat panel display at the same time. In this way, everyone within the confined space will be viewing the same video information regardless of which backpack they may be seeing within their proximity.

Alternatively, the centrally located transmission unit 92 may send out a multiplexed video signal having particular video segments, with each video segment being preceeded by an identifier which is used to identify the particular video equipped backpack for which that segment is intended. In this embodiment, the receiving unit 20 within each backpack will receive the same signal; but, using the identifier, each receiving unit 20 will filter out all of the segments except for the one intended to be received and played by that particular backpack. Then, only that video segment will be transmitted to the flat panel display video equipped backpack will display only that video information intended to be received by that backpack and everyone within the confined space will be viewing different video information, depending upon which backpack they may be seeing within their proximity.

As explained earlier, the video communications system may also be entirely self contained. In this embodiment, the image source contained within the backpack will be comprised of a small miniature optical disc player, portable DVD player, or mini-computer with video processing unit 20 along with a power supply 22, such as a portable rechargeable lithium battery, or the system may include a broadcast video signal receiving unit.

While the description above contains many specifics, these should not be construed as limitations on the scope of the invention, but rather as exemplifications of particular embodiments thereof. One of ordinary skill in the art may made many changes, modifications, and substitutions without necessarily departing from the spirit and scope of the invention. For example, the flat panel display may be coupled to and integrated within the backpack using alternative methods and the invention is not intended to be limited in scope to any one particular method. Accordingly, the scope of the invention should be determined not by the embodiments described above, but by the appended claims and their legal equivalents.

What is claimed is:

1. A portable video display device comprising:
a backpack having shoulder straps and a rectangular shaped opening formed within the back panel of the backpack;
a flat screen display coupled to the back panel of said backpack such that a display area of said flat screen display is visible through the rectangular shaped opening;
an image source, housed within said backpack and coupled to the flat panel display which transmits video signals to the display for viewing.

2. The portable video display device of claim 1, wherein the image source is a small miniature optical disc player.

3. The portable video display device of claim 1, wherein the image source is a portable DVD player.

4. The portable video display device of claim 1, wherein the image source is a mini-computer with, video processing unit.

5. The portable video display device of claim 1, further comprising a small power supply coupled to the flat screen display and the image source.

6. The portable video display device of claim 5, wherein the small power supply is a portable rechargeable lithium battery.

7. The portable video display device of claim 1, wherein the rectangular shaped opening is surrounded on opposing sides by a plurality of miniature hook locking mechanisms positioned about the opening and coupled to the backpack.

8. The portable video display device of claim 7, wherein the flat screen display is preferably encased within and surrounded by an encasement having a plurality of miniature locking bars positioned at select intervals along both sides of the encasement.

9. The portable video display device of claim 8, wherein the plurality of miniature hook locking mechanisms positioned about the sides of the rectangular shaped opening in the backpack will engage with each of the plurality of miniature locking bars positioned along the sides of the encasement of the flat screen display, in order to couple the flat screen display to the backpack, thereby forming one integral backpack having a flat screen display included therewith and coupled thereto.

10. The portable video display device of claim 1, wherein the rectangular shaped opening is flanked on all four sides by a plurality of velcro strips positioned about the opening on the inside surface of the backpack.

11. The portable video display device of claim 10, wherein the flat screen display is preferably encased within and surrounded by an encasement having a plurality of velcro strips positioned on a front surface of said encasement on all four sides, adjacent to a display area of said flat screen display.

12. The portable video display device of claim 11, wherein the plurality of velcro strips positioned about the sides of the rectangular shaped opening on the inside of the backpack will engage with each of the plurality of velcro strips positioned on the front surface of the encasement of the flat screen display, in order to couple the flat screen display to the backpack such that the display area of the flat screen display is visible through the rectangular shaped opening and thereby forming one integral backpack having a flat screen display included therewith and coupled thereto.

13. A video equipped backpack comprising:
a rectangular shaped opening formed within a back panel of the backpack;
a flat panel display coupled to the back panel of said backpack such that a display area of said flat panel display is visible through the rectangular shaped opening;
an image source, housed within said backpack and coupled to the flat panel display which transmits video signals to the display for viewing.

14. The video equipped backpack of claim 13, wherein the rectangular shaped opening is surrounded on opposing sides by a plurality of miniature hook locking mechanisms positioned about the opening and coupled to the backpack.

15. The video equipped backpack of claim 14, wherein the flat panel display is preferably encased within and surrounded by an encasement having a plurality of miniature locking bars positioned at select intervals along both sides of the encasement.

16. The video equipped back pack of claim 15, wherein the plurality of miniature hook locking mechanisms positioned about the sides of the rectangular shaped opening in the backpack will engage with each of the plurality of miniature locking bars positioned along the sides of the encasement of the flat panel display, in order to couple the flat panel display to the backpack, thereby forming one integral backpack having a flat panel display included therewith and coupled thereto.

17. The video equipped backpack of claim 13, wherein the image source is a small miniature optical disc player.

18. The video equipped backpack of claim 13, wherein the image source is a portable DVD player.

19. The video equipped backpack of claim 13, wherein the image source is a mini-computer with video processing unit.

20. The video equipped backpack of claim 13, wherein the image source is a video signal receiving unit for receiving a broadcast video signal from a centrally located transmission unit.

21. The video equipped backpack of claim 20, wherein the centrally located transmission unit transmits a multiplexed video signal having particular video segments preceeded by an identifier and further wherein the receiving unit will utilize the identifier to filter out all of the video segments except for the one intended to be received and played by that particular backpack.

22. A video communications system for transmitting and displaying video images within an enclosed space, the system comprising:
a centrally located video signal transmission unit which will broadcast a video transmission signal over a wireless intranetwork set up within the enclosed space a plurality of video equipped backpack systems moveably positioned throughout the enclosed space and worn by individuals who will each, in turn, move about the enclosed space, thereby allowing the video equipped backpack systems to move about the enclosed space, wherein each video equipped backpack system includes:
a rectangular shaped opening formed within a back panel of the backpack;
a flat panel display coupled to the back panel of said backpack such that a display area of said flat panel display is visible through the rectangular shaped opening;
a video signal receiving unit coupled to the flat panel display for receiving the broadcast video signal from the centrally located transmission and providing the video signal to the flat panel display for viewing on the display; and
a small power supply coupled to both the flat panel display and the video signal receiving unit.

23. The video communications system of claim 22, wherein the centrally located transmission unit transmits a multiplexed video signal having particular video segments with each segment being preceeded by an identifier and further wherein the receiving units in each video equipped backpack will utilize the identifier to filter out all of the video segments except for the one intended to be received and played by that particular backpack.
